(19) United States
(12) Patent Application Publication
(10) Pub. No.: US 2022/0122093 A1
(43) Pub. Date: Apr. 21, 2022

(54) CONSUMER PRODUCT AUTHENTICATION SYSTEM

(71) Applicant: Binh DO, Vancouver, WA (US)

(72) Inventor: Binh DO, Vancouver, WA (US)

(21) Appl. No.: 17/506,470

(22) Filed: Oct. 20, 2021

Related U.S. Application Data
(60) Provisional application No. 63/094,234, filed on Oct. 20, 2020.

(51) Int. Cl. G06Q 30/00; G06K 19/06; G06K 19/077; B65D 81/26

(52) U.S. Cl. CPC G06Q 30/0185; G06K 19/06009; G06K 19/0776; B65D 2585/56; B65D 2203/02; B65D 2401/00; B65D 81/268

(57) ABSTRACT

An insert having machine-readable code, including systems for producing the inserts and systems for reading the machine-readable code and transmitting/obtaining the information, is considered. The machine-readable code, which is optically readable by a device, is printed onto the insert, which is sized and shaped to be inserted into a container. A device can read the machine-readable code, such as by an optical reader. After reading the machine-readable code, the device can obtain information related to a consumer product to which the machine-readable code is related via an application which requests the information from a server or from memory within the device.

### CROSS-REFERENCE TO RELATED APPLICATION

This application claims priority and benefit from U.S. Provisional Application No. 63/094,234, filed Oct. 20, 2020, the contents of which are herein incorporated by reference in its entirety.

### BACKGROUND

Consumers are requiring greater transparency when it comes to information about the products they purchase, including where the materials are sourced, where the final product is packaged, when it was packaged, who packaged it, and who manufactured it. Brand owners or manufacturers can also determine trends regarding their products, including purchase and distribution locations, including new and emerging markets.

Consumers are concerned about what is actually in the supplements they take, including additives or other supplements which unintentionally get into the product they take, such as by cross-contamination. For example, in 2019, one NFL player was suspend for failing a drug test, which he claims was due to allegedly “contaminated” supplements. In 2008, five NFL players were suspended for failing a drug test after taking the same allegedly “contaminated” supplements.

Consumers are also concerned about contaminated foods and the resulting recalls. In 2019, the United States had an E. coli outbreak that was linked to romaine lettuce. Romaine lettuce was pulled from shelves to protect consumers. There was also a salmonella outbreak in raw beef. The raw beef was recalled, as well.

Consumers are also concerned about the ethical sourcing of materials, whether it is for food, supplements, clothing, or other consumer products. Consumers want to ensure the products were not created with materials which were obtained in harmful or destructive ways, such as to the environment, wildlife, natural resources, and the like.

The current systems set forth are, at best, inefficient and, at worst, error-prone at providing information to the consumer about the various products they consume and at identifying individual batches or shipments, such as those which may need to be recalled. The challenge is the ability to relay all of the appropriate and desired information to the consumer in an efficient, secure manner. For example, it is easy to tamper with information on the outside of labels. Labels can also be easily copied and duplicated. Also, due to the size of various containers, not all of the information can be supplied to the consumer without making a larger container, which is undesirable to the brand owner or manufacturer due to unnecessary cost increases.

What is needed is a system or method for providing information about a product within a container. What is further needed is that the system or method be secure to ensure that the information provided to the consumer is accurate and has not been tampered or altered. What is further need is that the system or method be efficient in providing the information to the consumer so that the consumer gains access to the information on-demand or within a desired time frame.

### BRIEF DESCRIPTION OF THE DRAWINGS

FIG. 1 illustrates an example container including an insert.

FIG. 2 illustrates an example system for adding an insert to a container.

FIG. 3 illustrates an example network.

FIG. 4A illustrates an example portion of a graphical user interface to request consumer product information.

FIG. 4B illustrates an example portion of a graphical user interface having received consumer product information.

FIG. 5 illustrates an example portion of a graphical user interface to input consumer product information related to the consumer product.

### DETAILED DESCRIPTION

Various example inserts having machine-readable code, including systems for producing the inserts and systems for reading the machine-readable code and transmitting/obtaining the information, are described herein. The machine-readable code, which is optically readable by a device, is printed onto the insert, which is sized and shaped to be inserted into a container. A device can read the machine-readable code, such as by an optical reader. After reading the machine-readable code, the device can obtain information related to a consumer product to which the machine-readable code is related via an application, which requests the information from a server or from memory within the device.

In the following description, the term “machine-readable code” is used to describe a code, capable of being read optically by a machine, which contains information about the item or object to which it is attached or into which it is inserted, or another item or object added to or inserted into the same container as an insert having the machine-readable code. The code can include an image, text, text string, matrix, numerical string, or a combination thereof. For example, the code can be a one-dimensional barcode, a two-dimensional barcode (e.g., QR Code or DataMatrix), a three-dimensional barcode, or a combination thereof.

The machine can be or can include an optical reader, such as a camera, an optical character recognition device, an optical mark recognition device, a barcode scanner, or the like.

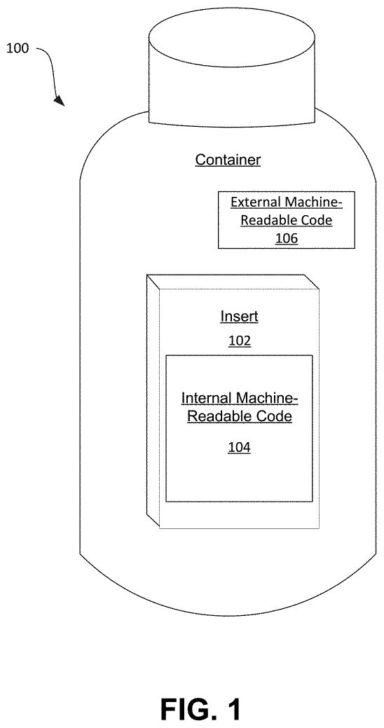

FIG. 1 illustrates an example container 100 including an insert 102. The insert 102 can be sized and shaped to fit within the container 100. The insert 102 includes an internal machine-readable code 104, which can be printed directly onto a main body of the insert 102 or printed onto a label which is then adhered to the main body of the insert 102. Alternatively, the internal machine-readable code 104 can be embossed onto or pressed into the insert 102.

The insert 102, and any portion thereof, including the ink used to print the internal machine-readable code 104 or the label onto which the internal machine-readable code 104 is printed and adhered to the insert, is inert or non-reactive with the consumer product included in the container—this inhibits degradation or one or more changes in the characteristics, properties, effectiveness, the like, or combinations thereof of the consumer product due to the internal machine-readable code 104, the insert 102, or combinations thereof. The insert 102 can be a desiccant, such as a pouch or a cylinder. The insert 102 can be formed from any appropriate material, including, without limitation, plastic, polymers, paper, cloth, fabric, felt, metal, the like, or combinations thereof.

In one embodiment, the insert 102 can include a plurality of internal machine-readable codes 104. Each of the internal machine-readable codes 104 can be directed to one or more pieces of information. The one or more pieces of information can be unique information or can have common or shared information. In one embodiment, the insert 102 can include a cover or insert package (not shown). The cover or insert package can be optically clear (i.e., transparent or translucent) to permit visualization, by at least an optical reader, of the machine-readable code.

The container 100 can be a bottle or box. The container 100 can be formed from any appropriate material, including, without limitation, plastic, polymers, glass, metal, cardboard, ceramic, the like, or combinations thereof. In one embodiment, the container 100 can include multiple inserts 102. Each of the multiple inserts 102 includes one or more internal machine-readable codes 104, which can be directed to one or more pieces of information. The one or more pieces of information can be unique information or can have common or shared information.

The consumer product in the container 100 can include, without limitation, supplements (e.g., vitamins, minerals, protein, creatine, amino acids, etc.), food, clothing, furniture, electronics, toys, and the like.

The container 100 also includes an external machine-readable code 106 that is affixed or secured to an exterior surface of the container 100. For example, the external machine-readable code 106 can be adhered to the exterior surface of the container 100 using an adhesive or glue. The external machine-readable code 106 includes data related to the consumer product stored in the container and can either compliment, validate, or duplicate the data that is on the internal machine-readable code 104. The combination of the external machine-readable code 106 and the internal machine-readable code 104 provide a dual authentication system that prevents counterfeits, helps identify specific consumer product that may be contaminated, or otherwise identifies targeted batches of products with as little waste as possible.

For example, the external machine-readable code 106 includes large batch information that identifies the location and a date on which the consumer product was manufactured or packaged. The external machine-readable code 106 is helpful to allow handlers of the consumer products to scan the code and know the location and date of manufacture (or any other included data) to track the products throughout the chain of commerce. However, the external machine-readable code 106 is accessible by any person or entity handling the consumer goods throughout the chain of commerce and could be subject to tampering, copying, or removal. The internal machine-readable code 104 is secured within the container 100 and cannot be accessed by any handler along the chain of commerce without breaking a seal or securing mechanism, such as a tamper-resistant cap or wrap that surrounds a cap to the container 100. Such a breaking of the seal or securing mechanism indicates that the consumer product is potentially exposed to contamination or has been damaged. Contaminated products—as indicated by a broken seal or securing mechanism—are often discarded and not able to be sold regardless of whether they are authentic and counterfeit.

By also including an insert with the internal machine-readable code within the sealed or secured container 100 in addition to the external machine-readable code 106, the container 100 has a dual authentication system. If the external machine-readable code 106 is damaged, removed, altered, copied or otherwise altered in any way, the internal machine-readable code 104 provides a second layer of authentication. After the consumer product reaches its end user, the user can break the seal or unsecure the securing mechanism to reveal the internal machine-readable code 104. The internal machine-readable code 104 includes data or information about the consumer product that duplicates, validates, or adds to the data or information included in the external machine-readable code.

For example, a manufacturing batch number and production date are encoded onto the external machine-readable code 106. The internal machine-readable code 104 includes the product identification and additional specific information about product ingredient sources and the like. Should a seller need to recall the consumer product, the batch number would include a wide variety of consumer products produced or packaged on a particular date. However, it would likely be over-inclusive to remove all of that product from market if only an ingredient provided by a particular source was contaminated while other sourced ingredients of the same batch were uncontaminated. By tracking the external machine-readable codes, the batch could be found to have been sent to a specific geographic region. Within that region, any end user could be notified to scan their internal machine-readable code for any that matched a short list of products that were known to have ingredients sourced from a particular contaminated source.

In another example, a counterfeit could be produced by copying the external machine-readable code and the consumer product, but the internal code could only be printed by the authentic manufacturer from at an approved manufacturing or packaging facility. This increases the likelihood of end users being easily able to identify counterfeit products, which are often lower quality or sourced from an unknown entity.

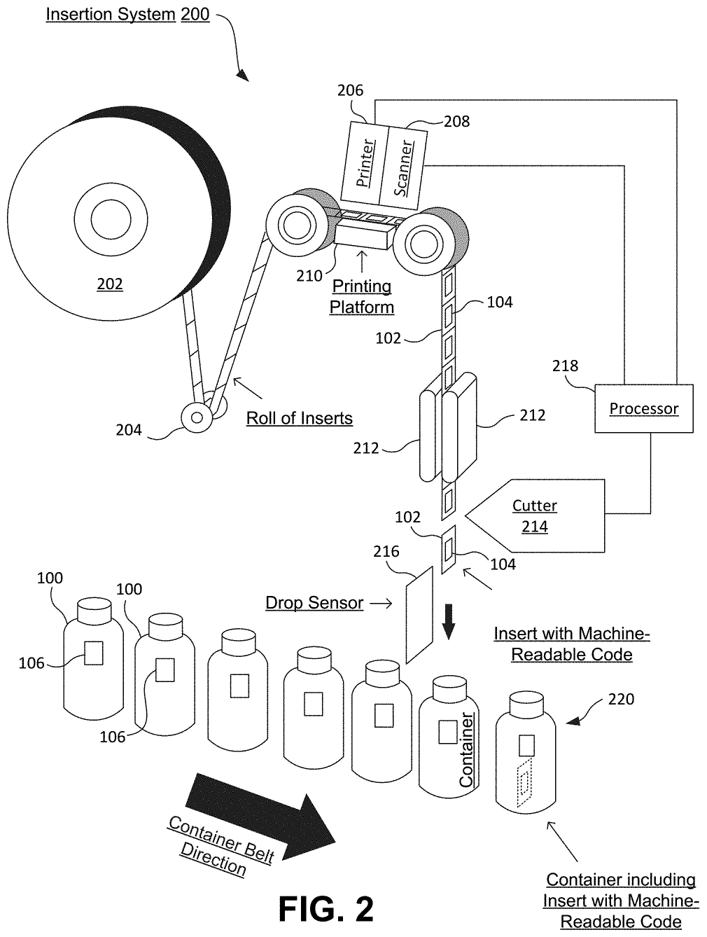

FIG. 2 illustrates an example insertion system 200 for adding the insert 102 to a container 100. In the example system 200, the insert 102 is a desiccant pouch. A plurality of inserts are provided in a roll 202, such that adjacent inserts are initially adjoined to each other. The roll of inserts 202 is placed onto a first spool 204 in the example shown in FIG. 2 although alternative configurations of dispensing the inserts can be implemented. The system 200 activates the first spool 204, which causes the roll 202 to begin dispensing a series of inserts 102. The series of inserts 102 is passed through or passed by a printer 206, which prints the internal machine-readable code 104 onto an outer surface of each insert 102. The printer 206 can be a high-resolution printer capable of printing the internal machine-readable code 104 onto the inserts 102. The printer 206 can print at a rate of 1 insert per second, 2 inserts per second, 3 inserts per second, 4 inserts per second, 5 inserts per second, 10 inserts per second, 0.1 to 20 inserts per second, or the like.

In one embodiment, the ink for printing is quick drying. The ink can dry in less than 0.1 seconds, 1 second, 2 seconds, 3 seconds, 4 seconds, 5 seconds, 10 seconds, or the like. In one embodiment, the ink dries at a rate equal to or less than (i.e., faster than) the rate at which printing occurs. For example, if the print rate is 10 inserts per second, then the ink dries in 0.1 seconds or less. In another embodiment, the ink can dry in less time than it takes for the insert, after printing, to travel to a scanner, or where a scanner is not present, to a cutter or a container. For example, if the insert takes 0.5 seconds to reach a scanner, cutter, or container (whichever is first), the ink dries in less than 0.5 seconds. However, the ink can dry in the same amount of time it takes to reach the scanner, cutter, or container, whichever is first. The ink can include magnetic particles to be used in a magnetic image recognition system.

FIG. 2 shows a scanner 208 positioned next in succession of the roll of inserts 202 after the printer 206. Though FIG. 2 depicts the printing and scanning as being performed horizontally or in succession, the printing, scanning, or both can be performed vertically or could be spaced apart, as needed. Further, the printing can be performed horizontally and the scanning can be performed vertically, or vice versa.

In one embodiment, the insertion system 200 includes a printing platform 210 to maintain a firm, flat surface for the one or more inserts 102 during printing so that there are no inconsistencies or deformities on the outer surface of the insert 102. Removing or inhibiting the inconsistencies or deformities of the outer surface, such as the surface of the insert 102 onto which printing occurs, helps prevent optically unreadable, internal machine-readable code 104 (for example, smearing, smudging, uneven printing, undesired spaces or gaps, etc.) from occurring. This also allows for consistent printing across multiple inserts.

After the internal machine-readable code 104 is printed onto the insert 102, the internal machine-readable code 104 can be scanned with the scanner 208. The scanner 208 reads the internal machine-readable code 104 of the insert 102 to ensure that the internal machine-readable code 104 is correct for the product into which the associated insert 102 is being added, that the internal machine-readable code 104 is capable of being read by an optical reader of a machine (e.g., no smudging, smearing, incorrect or missed characters, improper or incorrect image, and the like), or a combination thereof. The scanner 208 can be high-resolution. In one embodiment, the scanner 208 can read the internal machine-readable code 104 at a rate equal to or greater than the rate at which the printer 206 prints the internal machine-readable code 104 onto the insert 102.

After scanning, the inserts 102 can be fed through an optional guide 212 into a cutter 214. The cutter 214 separates each insert into single inserts 102 with respective internal machine readable codes 104. The cutter 214 can be any blade or instrument capable of separating the adjoining inserts 102. The now-separated insert 102 with the internal machine readable code 104 is added to the container 100 by any suitable means, such as gravity (i.e., the insert 102 drops into an opening of a container 100), by a manifold (not shown) which directs an insert 102 to the container 100, or by a gripper (not shown) which adds the insert 102 directly to the container 100. When the container 100 already includes the consumer product, the container 100 can be sealed and prepared for shipping after the insert 102 with the internal machine readable code 104 is inserted. When the container 100 does not yet include the consumer product when the insert 102 is placed into the container 100, the consumer product can be added to the container 100, and then the container 100 can be sealed and prepared for shipping.

To seal the container 100, a sealing mechanism (not shown), such as a lid, cap, or flap(s) is positioned over an opening in the container 100, and then an optional sealant is applied to secure the sealing mechanism to the container 100. For example, the sealant can be an adhesive (e.g., glue, tape, epoxy, or the like), a tamper-proof band, a plastic seal, shrink-wrap, the like, or combinations thereof.

The system 202 can also include a drop sensor 216. The drop sensor 216 can monitor the inserts 102 as they are placed into each respective container 100. For example, the drop sensor 216 monitors the insert 102 placement into respective containers 100 to ensure each container 100 includes an insert 102 and only one insert is added to each container 100. The drop sensor 216 can determine whether no inserts 102 were added to the container 100 or more than one insert 102 was added.

Any or all of the components of the insertion system 200 are electrically coupled to a processor 218. The processor controls or instructs the movement of the inserts through the system 200, the placement or printing of the internal machine-readable code onto the insert, the cutting of each insert into individual inserts with the internal machine-readable code, the drop sensor that detects the placement of the inserts into the containers, the containers as they each move along the production belt, and so on. Ultimately, the processor 218 authenticates each finished container 220 that has both the external machine-readable code on the external surface of the container and the internal machine-readable code on the insert within the container as it is created.

Though the above system discloses a roll of inserts being desiccant pouches, the inserts can be any of the inserts discussed above, such that the system is adjusted based on the characteristics or properties of the inserts. For example, the inserts can be desiccant cylinders, which are provided individually rather than in roll form. Such a system with a different form of an insert does not require the cutter (since the inserts do not need to be separated), the original spool, or extra rollers to form a line from a roll of inserts. As yet, another example, the inserts can be paper flyers, which can require a similar system setup to the desiccant pouches.

In one embodiment, the insertion system 200 can include a label maker to print and make the labels to be adhered to the insert. In one embodiment, such as where the labels are pre-printed, the insertion system 200 can include a machine to adhere the labels to the respective inserts 102.

In one embodiment, the internal machine-readable code 104 can be pre-printed onto the inserts or pre-adhered, via labels, to the inserts 102 prior to adding the inserts 102 into the system 200 for insertion into the container 100. Therefore, the system 200 does not require the printer 208, though the scanner 208 is still recommended to track the data on each insert 102 that is going into respective containers 100. The printing can be performed off-site or within a separate system. The off-site or separate system can further include a scanner for the same reasons as those discussed above.

The example containers 100 shown in FIG. 2 include an external machine-readable code 106 that can be added as a separate step in this example system 200 or could be added to the containers before they enter the example system 200. After the inserts with the internal machine-readable code are placed into the containers with the external machine-readable code, the containers are ready to be sealed or secured closed for further shipping or processing along the chain of commerce.

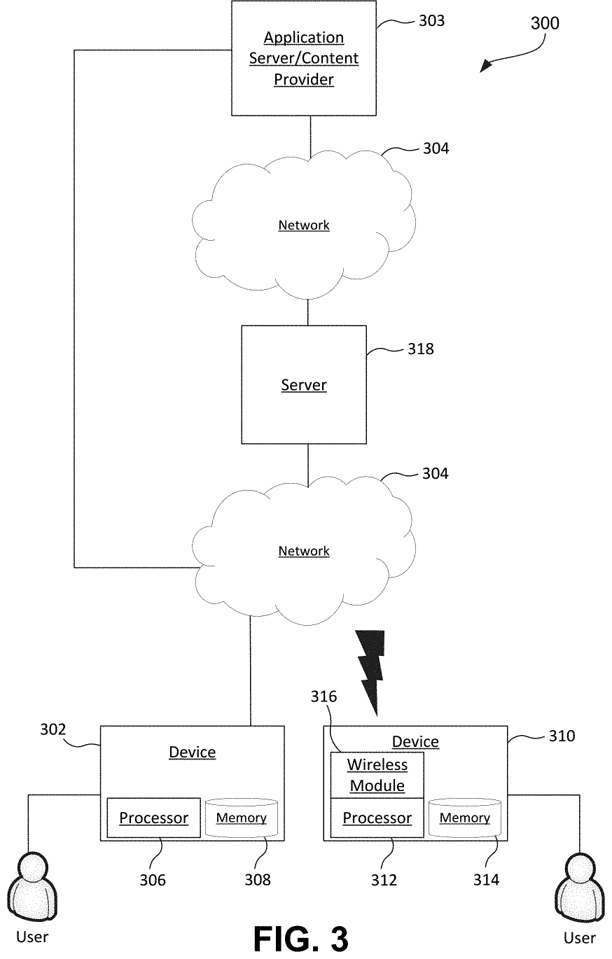

FIG. 3 illustrates an example network 300 for requesting and providing information relating to the machine-readable code of the insert. A first device 302 can be hardwired (e.g., Ethernet cable) to a network 304 (for example, WAN, PAN, WLAN, LAN, or the like). The first device 302 can include a processor 306 and a memory 308. A second device 310 can be wirelessly connected to the same network 304 as the first device 302 or to a different network. For ease of depiction, only one network is shown, though each device can connect to a different network based on the type of connection, desired speed, connection security, or the like. The second device 310 can include a processor 312, a memory 314, and a wireless module 316. The wireless module 316 of the second device 310 can connect to the network 304 via a wireless connection or protocol, including, without limitation, Bluetooth, WiFi, cellular signal, or the like. The first and second devices 302, 310 can be a computer, a smartphone, a laptop, a tablet, a personal digital assistant, a smartwatch, or the like. The first and second devices 302, 310 can be the same type of device or different types of devices. Furthermore, the first and second devices 302, 310 can each include an optical reader (not shown), or the optical reader can be separate from, but in communication with, the first or second devices 302, 310. The optical reader is a device which obtains visual information and converts or translates the visual information into digital information, which another device, such as a computer, can understand, process, display, or the like. The optical reader can be a camera, an optical character recognition device, an optical mark recognition device, a barcode scanner, or the like.

For ease of description, the network 304 is discussed in connection with the second device 310—a smartphone including a camera—and an application 303, such that the smartphone is wirelessly connected to the network 304. However, as discussed above, the first device 302 can be used instead of or in addition to the second device 310. In one embodiment, the first and second devices 302, 310 can be in communication with each other, such that the second device 302 reads the internal or external machine-readable code and the first device 302 provides information, which it has previously stored relating to the consumer product in the container.

The user, having downloaded the application 303 to the smartphone, opens the application 303 (or, alternatively, opens a web browser and directs the web browser to a website). The application 303 requests the use of the smartphone camera to capture the external machine-readable code on the container and internal machine-readable code of the insert. After providing permission for the camera, the user places the internal machine-readable code of the insert in a place which is viewable by the camera. The camera, whether automatically or by action of the user, captures both the external and internal machine-readable codes, such as in a photo or in a digital hash or signature. The application 303, based on the captured machine-readable code, sends an information request to one or more servers. The information request is a request from the one or more servers regarding the information related to the consumer product associated with the external and the internal machine-readable codes. The information on one or both of the external and the internal machine-readable codes includes, without limitation, brand owner name, a product image, packaging image, product name, product description, manufacturer name, manufacturer location, ingredients, ingredient sources, packaging company, packaging location, packaging site number, and the like, and combinations thereof. The information can ensure that both the external and the internal machine-readable code is authenticated to the consumer product in the container. The information can provide relevant manufacturing and packaging information to the consumer, for example.

The one or more servers 318 can be an intermediate server in communication with an application server or content provider. Or, the one or more servers 318 can be the application server or content provider. Each of the servers can be associated with one or more networks to properly transmit the desired information.

Though an application is discussed, the first or second devices 302, 310 can transmit and receive information via a website. The application and website can include one or more communication protocols, including HTTP or HTTPS, security protocols, including encryption, or both.

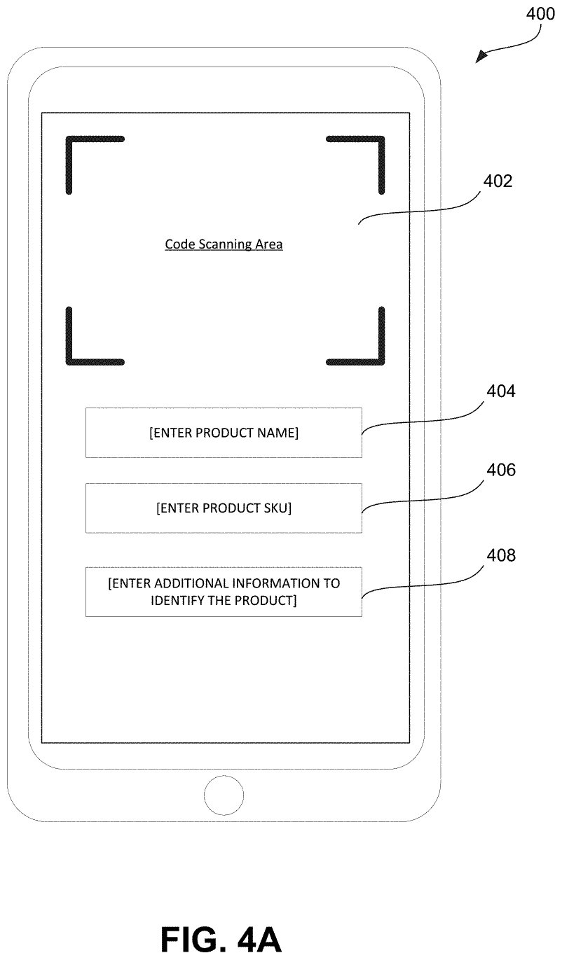

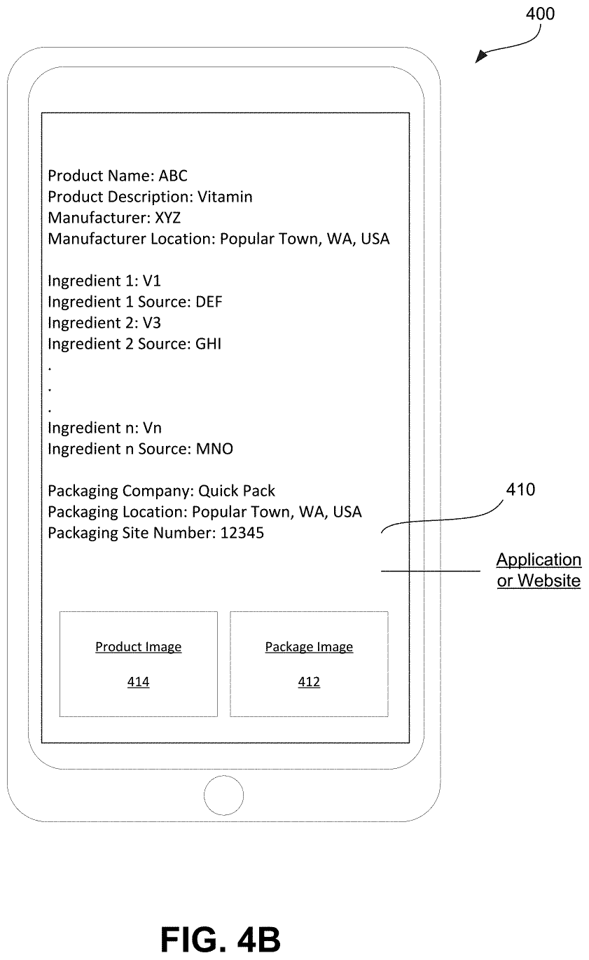

FIG. 4A illustrates an example portion of a graphical user interface 400 to request consumer product information. The graphical user interface 400, which can be a portion of an application or a website, includes a code scanning area 402 to view and capture the machine-readable code of the consumer product. The application or website can be downloaded onto or run on the first or second devices 302, 310.

The user can also input into the application one or more pieces of information about the consumer product when requesting the consumer product information, such as the product name 404, the product SKU 406, and other additional information that helps to identify the product 408. The input can be a dropdown menu or text box. The input can be performed in addition to the code scanning, such as to act as a check or confirmation that the machine-readable code of the insert is associated with the proper consumer product. For example, a correct association can return information about the consumer product, whereas an incorrect association can return an error message.

FIG. 4B illustrates an example portion of a graphical user interface 400 having received consumer product information. The graphical user interface, which can be a portion of an application or a website, can be downloaded onto or run on the first or second devices 302, 310.

The application or website 410 provides information related to the product with which the machine-readable code is associated. As discussed above, the information includes, without limitation, brand owner name, a product image, packaging image, product name, product description, manufacturer name, manufacturer location, ingredients, ingredient sources, packaging company, packaging location, packaging site number, and the like, and combinations thereof. The information can provide relevant manufacturing and packaging information 412 to the consumer. The information can ensure that the machine-readable code is related to the proper product. For example, the product image 414, the package image, or a combination thereof, can allow the consumer to check and ensure that the machine-readable code is associated with the proper consumer product by displaying the consumer product associated with the machine-readable code in the server or database.

In one embodiment, the application or website can also be used to provide consumer information to the brand owner, manufacturer, or distributor. For example, the consumer information can include purchase location, distribution location, distributer, frequency of purchase, and the like, and combinations thereof. The consumer information can be used to make recalls more efficient by directly notifying the consumer. The consumer information can also be used to determine the markets in which the products are being bought or sold, such as to identify new and emerging markets for the consumer products. The application or website can request certain consumer information or provide it automatically to the brand owner, manufacturer, packager, distributer, and the like, or a combination thereof.

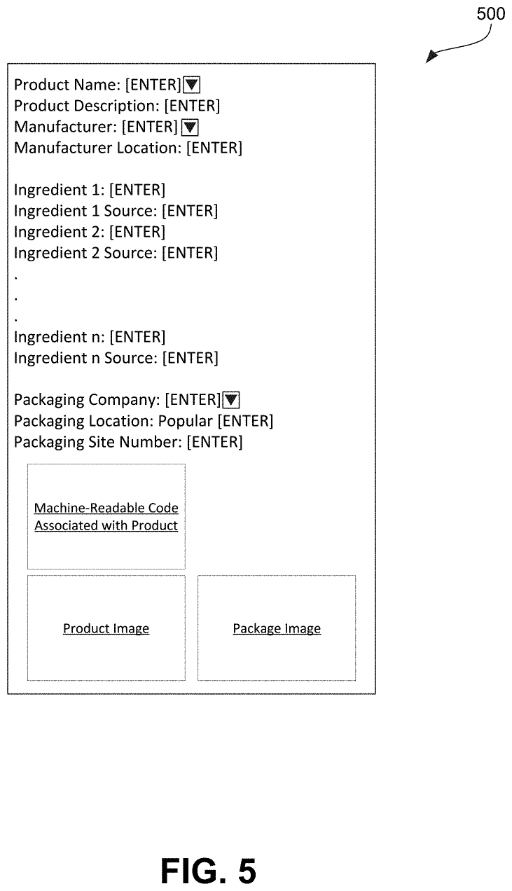

FIG. 5 illustrates an example portion of a graphical user interface, which can be a portion of an application or a website, to input consumer product information related to the consumer product. The brand owner, manufacturer, packager, distributer, and the like, or combination thereof, can input one or more pieces of information about the consumer product associated with the machine-readable code of the insert. The input can be a dropdown menu or text box.

In one embodiment, a machine-readable code generation system 500 is associated with the graphical user interface of FIG. 5, such that the brand owner, manufacturer, packager, distributer, and the like, or combination thereof can request one or more machine-readable codes. The requesting party can input the product information, such as for a product, a new batch of product, or a new lot of product, and request the generation of a new machine-readable code associated with the product generally, or, more specifically, the batch or lot, and the product information. The generation system then generates the machine-readable code associated with that product, the new batch, the new lot, or a combination thereof. For example, the generation system can generate one machine-readable code for a product generally; the generation system can also generate one machine-readable code for a new batch or a new lot of the product. The one or more machine-readable codes can be used in combination (e.g., printed on the same insert or label) or can be used separately.

Each machine-readable code is unique, such that no two machine-readable codes generated by the generation system are the same. In one embodiment, no two products (i.e., different products) have the same machine-readable code, such that each item of a batch or lot has the same machine-readable code. In one embodiment, each item of the same batch or lot of a product has a unique machine-readable code (i.e., no two items have the same machine-readable code). Though the product information is the same with items of the same batch or lot, different machine-readable codes can provide efficient, easier tracking, such as for recall purposes or consumer-based information.

In one embodiment, the brand owner, manufacturer, packager, distributer, and the like, or combination thereof, can register with the machine-readable code generation system (whether via the graphical user interface or a separate registration system), with another system associated with the machine-readable generation system, or both.

In one embodiment, the brand owner, manufacturer, packager, distributer, and the like, or combination thereof, having already registered and requested at least one machine-readable code, can add the generated machine-readable code to be associated with the product, batch, or lot via the graphical user interface or website.

In one embodiment, the machine-readable codes are sequential. Sequential machine-readable codes, for example, can provide efficient, easier tracking, such as for recall purposes or consumer-based information. In one embodiment, the machine-readable codes are sequential for each request. In one embodiment, the machine-readable codes are non-sequential.

Though brand owner, manufacturer, packager, and distributer are listed separately, one entity can perform one or more of the functions associated with the individual entities listed herein. The list of entities capable of using the machine-readable codes, generation system registration system, and graphical user interfaces, etc. is not intended to be limited to those discussed herein. Rather, the list is intended to provide example entities or parties.

Though certain elements, aspects, components, or the like are described in relation to one embodiment or example, those elements, aspects, components, or the like can be included with any other system, such as when it is desirous or advantageous to do so.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents.

What is claimed is:

1. A system for authenticating a consumer product stored in a container, comprising:
the container;
an external machine-readable code positioned on an external surface of the container and including data relating to the consumer product; and
an internal machine-readable code placed in the container and including data relating to the consumer product.

2. The system of claim 1, wherein the container has a seal or securing mechanism that is secured closed to store the consumer product and the internal machine-readable code in the container.

3. The system of claim 1, wherein the external machine-readable code is secured to the external surface of the container with an adhesive.

4. The system of claim 1, wherein the external machine-readable code includes data relating to a batch number associated with the consumer product.

5. The system of claim 1, further comprising an insert, wherein the internal machine-readable code is affixed to the insert.

6. The system of claim 1, further comprising an insert, wherein the internal machine-readable code is printed on the insert.

7. The system of claim 1, further comprising an insert that includes a desiccant.

8. The system of claim 1, wherein the data relating to the consumer product included in the external machine-readable code is the same as the data relating to the consumer product included in the internal machine-readable code.

9. The system of claim 1, wherein the data relating to the consumer product included in the external machine-readable code is different than the data relating to the consumer product included in the internal machine-readable code.

10. The system of claim 1, wherein the data relating to the consumer product included in the external machine-readable code includes a batch number of the consumer product and the data relating to the consumer product included in the internal machine-readable code includes a lot number of the consumer product.

11. The system of claim 1, wherein the consumer product is a supplement.

12. A method of creating an authenticated consumer product, comprising:
applying an external machine-readable code to a container storing a consumer product, the external machine-readable code including data relating to the consumer product;
applying an internal machine-readable code to an insert placed in the container and including data relating to the consumer product;
causing the insert to be placed into the container; and
securing the consumer product and the insert in the container.

13. The method of claim 12, wherein the external machine-readable code is applied to the external surface of the container with an adhesive.

14. The method of claim 12, wherein the internal machine-readable code is affixed to the insert.

15. The method of claim 12, wherein the internal machine-readable code is printed on the insert.

16. The method of claim 12, wherein the data relating to the consumer product included in the external machine-readable code is different than the data relating to the consumer product included in the internal machine-readable code.

17. A method of determining authenticity of a consumer product stored in a container, comprising:
receiving external machine-readable data imaged from an external surface of the container;
receiving internal machine-readable data imaged from an insert within the container;
determining that the external machine-readable data and the internal machine-readable data relate to the consumer product; and
outputting a validation of the consumer product based on the determination that the external machine-readable data and the internal machine-readable data relate to the consumer product.

18. The method of claim 17, wherein the external machine-readable data is associated with the consumer product, and wherein the validation includes comparing data from the external machine-readable data to stored data relating to the consumer product.

19. The method of claim 18, wherein the validation further includes comparing the data from the internal machine-readable data to stored data relating to the consumer product.

20. The method of claim 17, wherein the external machine-readable data and the internal machine-readable data are both associated with the consumer product, and wherein the validation includes comparing data from the external machine-readable data to the data from the internal machine-readable data.
